(19) United States
(12) Patent Application Publication
(10) Pub. No.: US 2005/0158509 A1
(43) Pub. Date: Jul. 21, 2005

(54) Punchable carbon/carbon composite plate and process for producing friction plate for multiplate wet clutch

(76) Inventors: Atsushi Takahashi, Saitama (JP); Yorinori Kumagai, Saitama (JP); Takao Nakagawa, Saitama (JP)

Correspondence Address: ARENT FOX PLLC, 1050 CONNECTICUT AVENUE, N.W., SUITE 400, WASHINGTON, DC, 20036, US

(21) Appl. No.: 10/504,774

(22) PCT Filed: Feb. 19, 2003
(86) PCT No.: PCT/JP03/01777

(30) Foreign Application Priority Data
Feb. 20, 2002 (JP) 2002-43668
Dec. 12, 2002 (JP) 2002-361200

(51) Int. Cl. B32B 5/00; B29C 67/00

(52) U.S. Cl. 428/98; 264/136

(57) ABSTRACT

A carbon-carbon composite plate (1) for stamping is provided, the carbon-carbon composite plate having a porosity P of 20% or greater, and the stamping being carried out in the absence of water, or the carbon-carbon composite plate having a porosity P of 10% or greater, and the stamping being carried out in the presence of water. This enables an intact plate-shaped member to be obtained by stamping.

### FIELD OF THE INVENTION

The present invention relates to a carbon-carbon composite plate for stamping and a process for producing a multiple plate wet clutch friction plate using the composite plate.

### BACKGROUND ART

When a plate-shaped member such as, for example, a multiple plate wet clutch friction plate is produced from a carbon-carbon composite plate, if the friction plate can be obtained by subjecting the carbon-carbon composite plate to stamping, it is possible to greatly improve the production efficiency.

However, since a conventional carbon-carbon composite plate has a high density and is rigid, when it is subjected to stamping there are the problems of cracking in sheared sections and peeling-off of a matrix occurring.

### DISCLOSURE OF INVENTION

It is an object of the present invention to provide a carbon-carbon composite plate for stamping, the carbon-carbon composite plate being capable of giving an intact plate-shaped member by stamping.

In order to attain this object, in accordance with the present invention, there is provided a carbon-carbon composite plate for stamping, the carbon-carbon composite plate having a porosity P of 20% or greater, and the stamping being carried out in the absence of water.

Since the composite plate having the above porosity P can be plastically deformed, it is possible to obtain an intact plate-shaped member by stamping in the absence of water. However, when the porosity P is less than 20%, cracking, etc., occurs in sheared sections.

Furthermore, in accordance with the present invention, there is provided a carbon-carbon composite plate for stamping, the carbon-carbon composite plate having a porosity P of 10% or greater, and the stamping being carried out in the presence of water.

Although when the porosity P is at the lower limit value or in the vicinity thereof, for example, when it is at least 10% but less than 20%, the composite plate has a relatively high density, an intact plate-shaped member can be obtained by virtue of a slipping action due to water during stamping. However, when the porosity P is less than 10%, even in the presence of water, cracking, etc. occurs in sheared sections. On the other hand, when P is equal to or greater than 20%, as described above, even without using water an intact plate-shaped member can be obtained.

It is also an object of the present invention to provide a process for efficiently producing an intact multiple plate wet clutch friction plate using a carbon-carbon composite plate.

In order to attain this object, in accordance with the present invention, there is provided a process for producing a multiple plate wet clutch friction plate having an annular plate shape with a spline on an inner peripheral section, and having, in a flat section between the inner peripheral section and an outer peripheral face, at least either a plurality of through holes arranged in the peripheral direction, or a plurality of slits that are arranged in the peripheral direction, extend from the inner peripheral section side, and open on the outer peripheral face, the process including subjecting a carbon-carbon composite plate having a porosity P of 20% or greater to a single stamping operation in the absence of water.

Furthermore, in accordance with the present invention, there is provided a process for producing a multiple plate wet clutch friction plate having an annular plate shape with a spline on an inner peripheral section, and having, in a flat section between the inner peripheral section and an outer peripheral face, at least either a plurality of through holes arranged in the peripheral direction, or a plurality of slits that are arranged in the peripheral direction, extend from the inner peripheral section side, and open on the outer peripheral face, the process including subjecting a carbon-carbon composite plate having a porosity P of 10% or greater to a single stamping operation in the presence of water.

In accordance with these production processes, the desired object can be achieved.

### BRIEF DESCRIPTION OF DRAWINGS

FIG. 1 is a perspective view of a carbon-carbon composite plate,

FIG. 2 is a front view of a friction plate of a first embodiment,

FIG. 3 is a sectional view along line 3-3 in FIG. 2,

FIG. 4 is a front view of a friction plate of a second embodiment,

FIG. 5 is a front view of a friction plate of a third embodiment, and

FIG. 6 is a front view of a friction plate of a fourth embodiment.

### BEST MODE FOR CARRYING OUT THE INVENTION

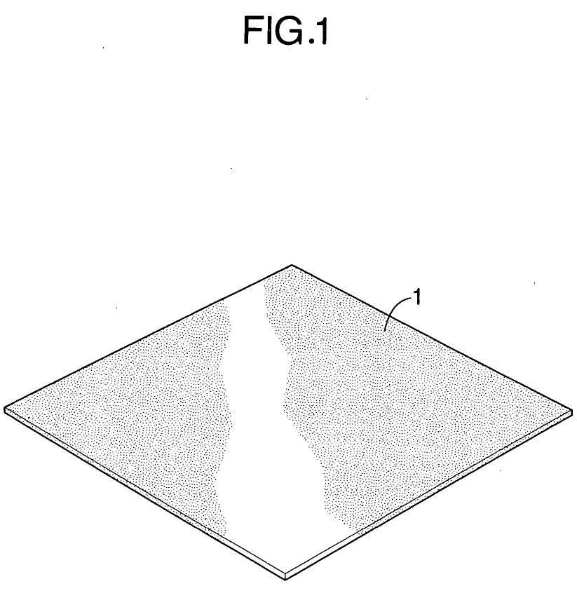

A carbon-carbon composite plate 1 shown in FIG. 1 has a structure in which a reinforcing material is carbon fiber and a matrix is carbon. Such a composite plate 1 was produced by the following method.

(1) A preformed yarn disclosed in Example 1 of Japanese Patent Publication No. 4-72791, that is, a bundle of carbon fibers with attached thereto a petroleum-based pitch powder binder and a coke powder, the bundle having been covered with a polyethylene sleeve having an outer diameter of 3 mm and a thickness of 8 μm, was cut into lengths of 1 to 30 mm and superimposed to give a mat-form material.

(2) The mat-form material was placed in a mold of a hot press and kept at a mold temperature of 250° C. for 10 minutes, the mold was subsequently tightened so as to apply a pressure of 10 MPa to the mat-form material, and the mold was cooled to room temperature in this state to give a rectangular molded plate.

(3) The molded plate was placed in a calcining furnace and carbonized under a nitrogen atmosphere at 600° C. to give the carbon-carbon composite plate 1.

(4) This composite plate 1 was subjected to finishing.

The carbon-carbon composite plate 1 obtained by this method had a porosity P of 5%. Using the same method as above, various types of carbon-carbon composite plate having a porosity P of greater than 5% were produced.

Table 1 shows the starting material composition, the porosity P, etc. of the various types of composite plate. In Table 1, Example 1 corresponds to the above embodiment, CF denotes carbon fiber, and Mx denotes a matrix. The carbon fiber does not change in volume.

TABLE 1

| | Starting material | | | Mx | | |
|---|---|---|---|---|---|---|
| Carbon- | composition | | Mx | proportion | CF | |
| carbon | CF | Mx | volatile | after | volume | |
| composite | A | B | ratio | calcining | fraction | Porosity |
| plate | (vol. %) | (vol. %) | C (%) | D (%) | Vf (%) | P (%) |
| Example 1 | 35 | 65 | 0.08 | 60 | 37 | 5 |
| Example 2 | 35 | 65 | 0.15 | 55 | 39 | 10 |
| Example 3 | 35 | 65 | 0.30 | 46 | 43 | 20 |
| Example 4 | 30 | 70 | 0.43 | 40 | 43 | 30 |
| Example 5 | 25 | 75 | 0.53 | 35 | 42 | 40 |
| Example 6 | 20 | 80 | 0.62 | 30 | 40 | 50 |
| Example 7 | 15 | 85 | 0.70 | 26 | 37 | 60 |
| Example 8 | 10 | 90 | 0.78 | 20 | 33 | 70 |

In Table 1, the Mx volatile ratio C was obtained from the decrease in weight at 600° C., the Mx proportion D after calcining was obtained from D=B·(1−C), the CF volume fraction Vf was obtained from Vf={A/(A+D)}·100, and the porosity P was obtained from P=B·C. As is clear from Table 1, the porosity P was adjusted by changing the Mx volatile ratio C and the starting material composition. In Examples 1 to 3, the Mx volatile ratio C was changed by changing the ratio by weight of the petroleum-based pitch powder binder to the coke powder. In Examples 4 to 8, the ratio by weight of the petroleum-based pitch powder binder to the coke powder was set so as to be constant.

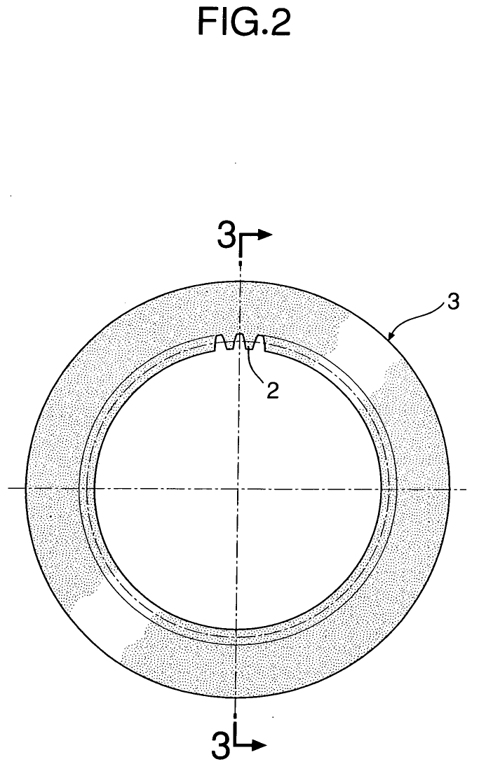

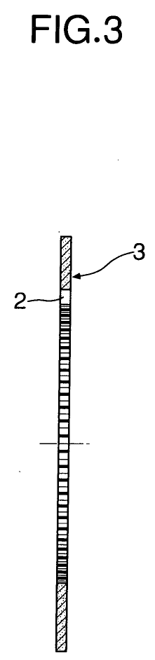

FIGS. 2 and 3 show a multiple plate wet clutch friction plate 3, and the friction plate 3 has a spline 2 on an inner peripheral section. Such a friction plate 3 was produced by subjecting the carbon-carbon composite plates of Examples 1 to 8 to a single stamping operation in the absence of water or in the presence of water. Table 2 shows the results. ‘In the absence of water’ referred to here means a state in which water is not forcibly applied to the composite plate, and ‘in the presence of water’ referred to here means a state in which the composite plate is immersed in water so that the composite plate contains sufficient water, and is then taken out of the water. In the table, X denotes a case in which cracking, etc. occurs in sheared sections and the product is not usable, A denotes a case in which, although the sheared sections are not sharp, since there is no cracking, etc. therein, the product can be used, and O denotes a case in which the sheared sections are sharp and the product can be put to practical use after simple finishing.

TABLE 2

| | |
|---|---|
| Carbon-carbon | Evaluation |

| composite | Porosity | In the absence of | In the presence |
|---|---|---|---|
| plate | P (%) | water | of water |
| Example 1 | 5 | X | X |
| Example 2 | 10 | X | Δ |
| Example 3 | 20 | Δ | Δ |
| Example 4 | 30 | Δ | ◯ |
| Example 5 | 40 | ◯ | ◯ |
| Example 6 | 50 | ◯ | ◯ |
| Example 7 | 60 | ◯ | ◯ |
| Example 8 | 70 | ◯ | ◯ |

It can be seen from Table 2 that, in order to obtain a usable friction plate 3 by stamping in the absence of water, the porosity P of the carbon-carbon composite plate 1 should be greater than that in Example 2, that is, P should be equal to or greater than 20%. In stamping in the presence of water, a usable friction plate 3 can be obtained by setting the porosity P of the composite plate 1 so that it is greater than that in Example 1, that is, so that P is equal to or greater than 10%. While taking into consideration the strength, coefficient of friction, etc., it is desirable for the porosity P of the friction plate 3 to be at least 10% but not greater than 70%. In this case, if the porosity P is less than 10% stamping cannot be performed, and if P is greater than 70% the strength is degraded.

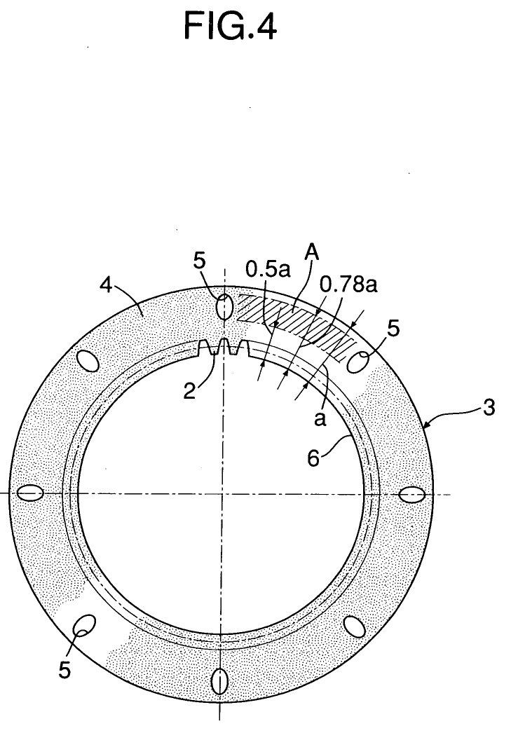

The friction plate 3 shown in FIG. 4 has an annular plate shape, and has a spline 2 on an inner peripheral section and a plurality of through holes 5 arranged in the peripheral direction in a flat section 4 between the inner peripheral section and an outer peripheral face. In this embodiment, eight oval-shaped through holes 5 are arranged at intervals of 45° in the peripheral direction with their major axes along the radial direction.

Such a friction plate 3 can be produced in the same manner as above by subjecting the carbon-carbon composite plate 1 having a porosity P equal to or greater than 20% to a single stamping operation in the absence of water, or by subjecting a carbon-carbon composite plate having a porosity P equal to or greater than 10% to a single stamping operation in the presence of water. By forming the plurality of through holes 5 on the flat section 4, it is possible to improve the ease of removal of an oil film when connecting the clutch, reduce the drag torque and, moreover, enhance the cooling performance of the friction plate 3.

Since the temperature of this type of friction plate 3 increases due to the heat of friction generated when connecting the clutch, a temperature variation is caused on the flat section 4. A range A in which the peak of this temperature variation is present is, when the width in the radial direction of the flat section 4 is defined as a, a range of about 0.5a to about 0.78a from the inner periphery (the tip of the spline 2) 6. By arranging each of the through holes 5 within the range A, it is possible to efficiently carry out cooling of the friction plate 3.

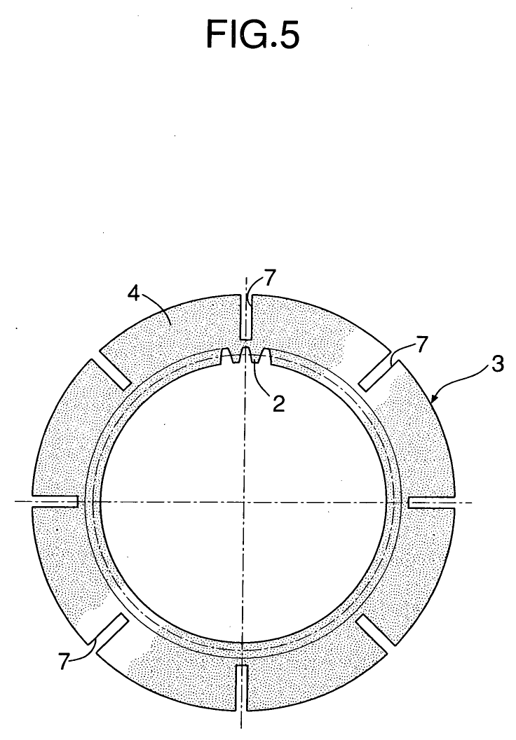

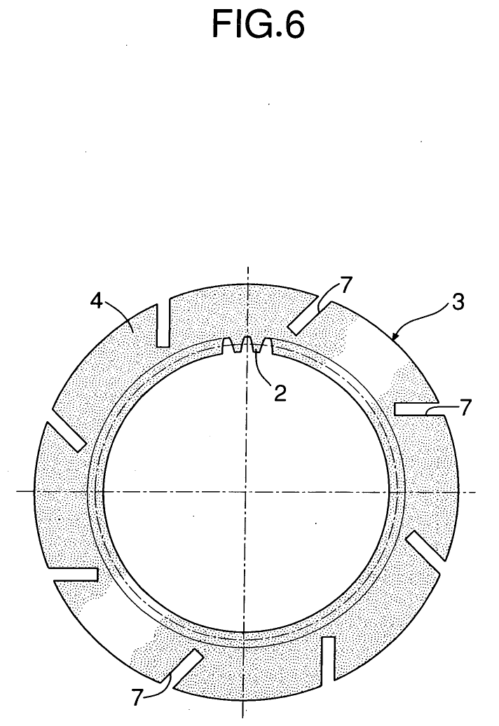

The friction plates 3 shown in FIGS. 5 and 6 have an annular plate shape and a spline 2 on an inner peripheral section and have, in a flat section 4 between the inner peripheral section and an outer peripheral face, a plurality, eight in these embodiments, of slits 7 arranged in the peripheral direction, extending from the inner peripheral section side, and opening on the outer peripheral face.

The eight slits 7 in FIG. 5 are arranged in a radial manner at intervals of 45° in the peripheral direction in the flat section 4, and the eight slits 7 in FIG. 6 are arranged at equal intervals in the peripheral direction and along virtual lines parallel to diameters. These friction plates 3 are produced by the same method as that used for the one in FIG. 4, and each slit 7 exhibits the same effect as that shown by each through hole 5.

With regard to other plate-shaped members obtained by stamping, there can be cited as an example a plate-shaped material for a gear having a porosity P of at least 10% but not greater than 70%.

1. A carbon-carbon composite plate for stamping, the carbon-carbon composite plate having a porosity P of 20% or greater, and the stamping being carried out in the absence of water.

2. A carbon-carbon composite plate for stamping, the carbon-carbon composite plate having a porosity P of 10% or greater, and the stamping being carried out in the presence of water.

3. A process for producing a multiple plate wet clutch friction plate having an annular plate shape with a spline on an inner peripheral section, and having, in a flat section between the inner peripheral section and an outer peripheral face, at least either a plurality of through holes arranged in the peripheral direction, or a plurality of slits that are arranged in the peripheral direction, extend from the inner peripheral section side, and open on the outer peripheral face, the process comprising subjecting a carbon-carbon composite plate having a porosity P of 20% or greater to a single stamping operation in the absence of water.

4. A process for producing a multiple plate wet clutch friction plate having an annular plate shape with a spline on an inner peripheral section, and having, in a flat section between the inner peripheral section and an outer peripheral face, at least either a plurality of through holes arranged in the peripheral direction, or a plurality of slits that are arranged in the peripheral direction, extend from the inner peripheral section side, and open on the outer peripheral face, the process comprising subjecting a carbon-carbon composite plate having a porosity P of 10% or greater to a single stamping operation in the presence of water.
